(19) United States
(12) Patent Application Publication
(10) Pub. No.: US 2016/0369079 A1
(43) Pub. Date: Dec. 22, 2016

(54) RETICULATED FOAM WONDER SPONGE

(71) Applicant: DOMENICA GAMBINO, GREAT NECK, NY (US)

(72) Inventor: DOMENICA GAMBINO, GREAT NECK, NY (US)

(21) Appl. No.: 14/745,552

(22) Filed: Jun. 22, 2015

(51) Int. Cl. C08J 9/38; A47L 13/16

(52) U.S. Cl. CPC C08J 9/38; A47L 13/16; C08J 2375/04; C08J 2205/05; C08J 2207/12

(57) ABSTRACT

The present disclosure, relates to an article, I call the “Reticulated Foam Wonder Sponge”. The Reticulated Foam Wonder Sponge, facilitates the removal of shedding pet hair, lint, and dust from a multitude of surfaces. The Reticulated Foam Wonder Sponge's relates to a previous invention, as revealed in U.S. Pat. No. 3,171,820 Granted Mar. 2, 1965.

### BACKGROUND OF THE INVENTION

Field of the Invention

This invention relates generally to a reticulated product I call, a “Reticulated Foam Wonder Sponge”, and is concerned with the ability to lift and remove pet hair, lint and dust from many surfaces. It is similarly concerned with the ability to exfoliate (the process of removing dead skin cells from the body) and to stimulate, and smoothen the rough parts of the body, accomplished, while bathing, using a body lotion or soap to facilitates the process.

Description of the Related Art

I have learned through my personal research and use that the Reticulated Foam Wonder Sponge, is a product made up primarily of a Polyurethane foam. It becomes electrostatically charged when stroked on most surfaces, thereby acting as a magnetic entity, attracting hair, lint and dust from clothing, beddings, sofas, carpets, rugs, interiors of vehicles, and many other surfaces. When the Reticulated Foam Wonder Sponge is cast, it is formed in a large block. It is then cut up into smaller configuration. The process slices through the labyrinth of the reticulated foam, leaving the strands on the surface of the sponge jagged. It is the combination of the jagged edges, plus the electrostatic charge that attracts and holds the hair, dust and lint, until they are physically removed from the surface of the sponge. I have further found another application for the Reticulated Foam Wonder Sponge. I have found the Reticulated Foam Wonder Sponge to be an excellent Exfoliator. When used in a bath together with a body lotion, or soap the Reticulated Foam Wonder Sponge, will stimulate and smooth the rough spots of your knees, elbows and feet, it will also aid in the removal of dead skin cells from your body. The unique structure of this Polyurethane foam sponge, reduces the retention of moisture, thereby reducing the effects of any bacteria buildup.

### CROSSREFERENCE OF THE INVENTION

1—Cross Reference of the Related Art

My invention the Reticulated Foam Wonder Sponge, is a Polyurethane foam. It relates to an earlier invention associated to U.S. Pat. No. 3,171,820 Granted Mar. 2, 1965.

2—Reference US Patent Documents Cited

U.S. Pat. No. 3,171,820 Granted Mar. 2, 1965

### FIELD OF CLASSIFICATION SEARCH

Class 510 (none found).

Class 015 (none found)

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable.

### SUMMARY OF THE INVENTION

### The Objective

The objective of my invention is to utilize the features of the Reticulated Foam Wonder Sponge to improve the process of removing pet hair, lint and dust from every home that has a pet. And to perform that task in a more economical and practical manner. The Reticulated Foam Wonder Sponge, has also proven to also be an excellent Exfoliator. Using it with soap and/or a body cream, will aid in smoothing the rough parts of the body. Using the sponge to bathe will also aid in removing dead skin cell from your body.

### The Process

The Reticulated Foam Wonder Sponge is most useful to remove pet hair, lint and dust by simply wiping the affected area. The cutting process of the foam, creates rough jagged strands on the surface. This together with the static electricity generated by the wiping process, creates an environment that attracts and holds foreign particles until they are physically removed.

### DESCRIPTION OF THE DRAWING

(Drawing on Separate Cover)

The Reticulated Foam Wonder Sponge. Is a Polyurethane foam. The composition is displayed as a 3 dimensional network of interconnecting strands. The mixtures of the polyurethane resin's characteristics are unique when viewed in a magnified environment.

FIG. 1—Is the view of the reticulated block foam in its original state, at its manufacture inception.

FIG. 2—Is a cross section view of the maze mass of the reticulated foam.

FIG. 3—Is the magnified cross section of a single strand that makes up the labyrinth that is the reticulated foam.

FIG. 4—Is a magnified cross section of the nucleus, of the labyrinth that make up the reticulated sponge.

FIG. 5—Is a single strand, demonstrating the characteristics qualities of the tip end of the cut strands.

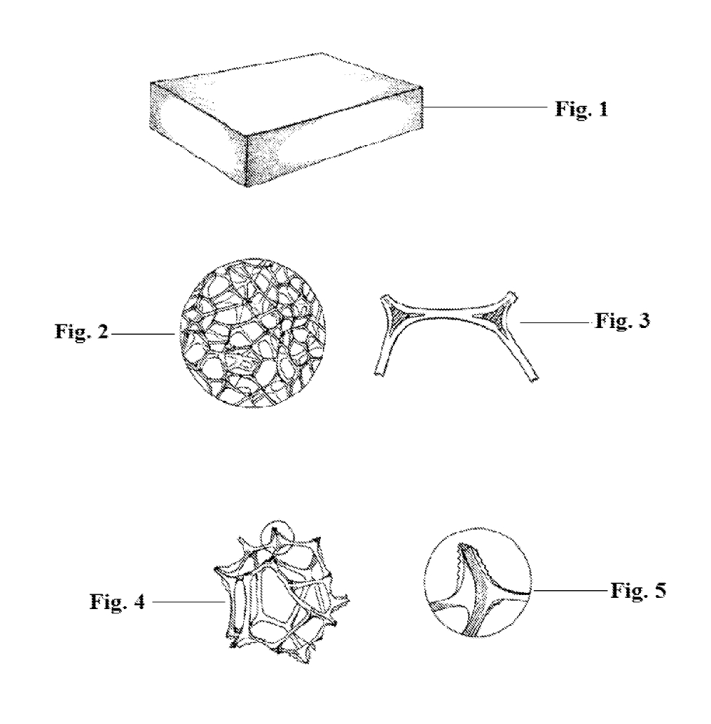

1. The Reticulated Foam Wonder Sponge is a 3-dimensional web of interlocking strands of a polyurethane resin formed by the reaction of a mixture of chemical agents as described in a U.S. Pat. No. 3,171, 820 granted Mar. 2, 1965

2. The Reticulated Foam Wonder Sponge facilitate the removal of hair, left behind by pets and any dust and lint laying on any surface. Simply wipe the surface with the Reticulated Foam Wonder Sponge over the area you want to clean.

3. The Reticulated Foam Wonder Sponge is also a great bath sponge. It is ideal for massaging your rough spots and removing dead skin cell from your body.

4. The Reticulated Sponge Wonder Foam can be configured into different sizes and colors.
